(19) United States
(12) Patent Application Publication
(10) Pub. No.: US 2006/0184871 A1
(43) Pub. Date: Aug. 17, 2006

(54) User friendly interface for installing and playing content

(75) Inventor: Keri Kallelis Waters, Santa Cruz, CA (US)

Correspondence Address: Naomi Obinata, 10427 Avenida Lane, Cupertino, CA, 95014, US

(73) Assignee: Molino Networks, Inc.

(21) Appl. No.: 11/056,594

(22) Filed: Feb. 11, 2005

(51) Int. Cl. G06F 3/00; G11B 27/00

(52) U.S. Cl. 715/512; 715/716; 715/854; 715/835

(57) ABSTRACT

A content display format that contains at least two levels of detail. In the first, or top level, there is a configuration of objects that designate different types of content for installing and playing on a player—for example, movies, music, photos, home video and a fifth option. Each of the content options is color-coded for ease of reference and is represented by a unique symbol, for instance, a pair of notes for designating music. When a user designates a content option, the display renders a second level of detail that displays a library of content files the designated content option. The user may select a desired content from the library and enjoy the content in a player.

### BACKGROUND OF THE INVENTION

The present invention relates to the field of graphical user interfaces. More particularly, the invention discloses a novel interface for interacting with a content storage/player device on a screen display, that is easily controlled via remote control.

Various user interfaces appear in the marketplace. One well-known interface is a “windows” interface for a computer, in which various icons representing programs or content appear on a screen, usually in a row-and-column format, against a background. A user may point to an icon with a computer mouse, click a button on the mouse, and cause the computer to “select” the designated icon. Usually, another screen appears and the user is then ready to interact with the computer using a combination of the mouse and a keyboard.

The “windows” and like interfaces, while touted as user friendly, are nonetheless designed to allow a user to perform a multitude of tasks typically loaded onto a computer. For instance, a user may read and write electronic mail, draft a document, prepare or manipulate a spreadsheet, listen to music, and surf the worldwide web on a single computing device. More and more, there is an interest to move the computer from the “home office” to the “family room” and thereby install onto the computer the capability for running applications typical on the computer (such as e-mail, etc.) but also to connect the computer to the stereo or to the television or both, so that music or movies could be installed onto the computer and played and enjoyed via the stereo or television screen.

A problem with a scheme of moving a computer to the family room and designating the computer to be an entertainment hub is that the computer remains a complicated piece of machinery. Not all people want to read and send electronic mail or create documents and use a keyboard and mouse within a family room setting. What is needed is an electronic appliance that includes a highly user-friendly interface that enables the installment and enjoyment of entertainment content.

### BRIEF SUMMARY OF THE INVENTION

An electronic appliance may include a computer readable medium having an application code that may implement a user interface amenable for playing and enjoying entertainment content. The content is provided in the electronic appliance, and the user interface includes a first graphical having a plurality of icons. Each of the icons is associated with a content category and may be selected for enjoyment. When an icon is selected, then a second graphical user interface appears, where the second graphical user interface displays an index of media files that are associated with the selected icon. The user may select one of the media files for viewing and/or listening as the case may be. When the user selects one of the media files, then a third graphical user interface appears. The third graphical user interface includes a written summary for the media file selected and a cover art associated with the selected media file is also displayed.

For music or other content that has a fixed duration of time, there is also a graphical indicator that allows the user to see the progress of the play. The graphical indicator displays a combination of a moving body linked with actual time, as well as a moving body that is linked with percentage completion of the content play.

### BRIEF DESCRIPTION OF THE DRAWINGS

The following figures augment the description of the preferred embodiments by providing graphical references to the descriptions herein. Where the figures include subfigures A, B, etc., such figures are intended to demonstrate the embodiments by way of example only and are not intended to limit the embodiments to only those shown.

FIG. 1 is a block diagram showing key components of a computing device.

FIG. 2 is representative of the top level of a graphic user interface in accordance with the present invention.

FIG. 3 is representative of a second level of the graphic user interface of FIG. 2.

FIG. 4 is representative of a third level of the graphic user interface of FIG. 2.

FIG. 5 is a flow diagram demonstrating the process of forming the user interface of FIG. 4.

FIG. 6 is a block diagram of a configuration of buttons on a control device that enables interaction with the graphic user interface of FIGS. 2-4.

FIG. 7 is a flow diagram demonstrating the process of using the graphic user interface of FIGS. 2-4.

### DETAILED DESCRIPTION OF THE INVENTION

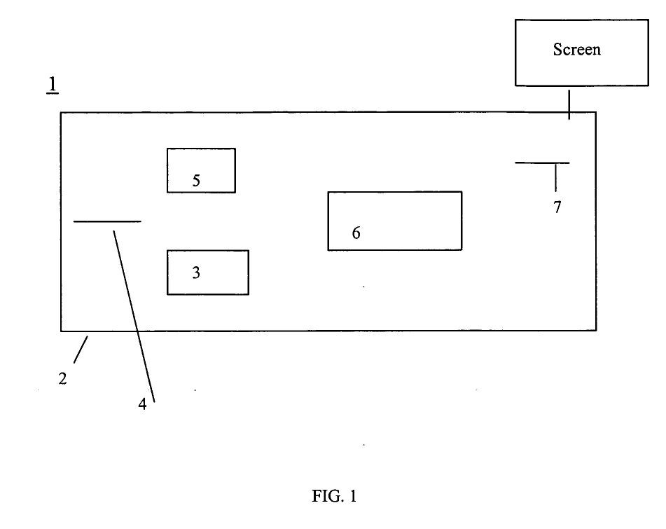

FIG. 1 represents an example of an overall computing device 1 on which the graphic user interface of the invention can be implemented. Computing device 1 is encased within a box 2. Pertinent features include at least a processor 3, which may include a data processor and a graphics processor. There is also an input port 4 for loading content preferably on an optical disk, a security layer 5 that is a software or hardware based mechanism to provide security against hacking, a file storage 6 which may be a hard disk, flash memory or other medium capable of storing a quantity of electronic files, and an output port 7 that enables the computing device 1 to be coupled to a viewing and/or audio device. All of the components within box 2 are interconnected in a generally known manner using wires, data buses and controllers (not shown) and a combination of hardware and software, as needed to enable the computing device 1 to function in the desired manner. The computing device 1 includes a computer readable medium, preferably a software application code programmed by a person skilled in the art, that implements a user interface (described more fully below). The user then may place a music or movie content or other content into the input port 4, and using commands to interact with the user interface (which is enabled by the computer readable medium), store the content along with other previously loaded contents in file storage 6. To play the content, the user interacts with the user interface again and selects the content, whereupon the content can be enjoyed on a screen or stereo or both.

The user interface is a thing that a person uses to interact with the computing device 1. The user interface is designed to convey in an easy-to-understand manner the options for type of content to enjoy and for enjoying the content, once the content is installed and placed in file storage 6 (this is also done using the interface). The user interface of the invention provides a process for selecting video, picture, music or other content from a pre-existing library and enjoying the content.

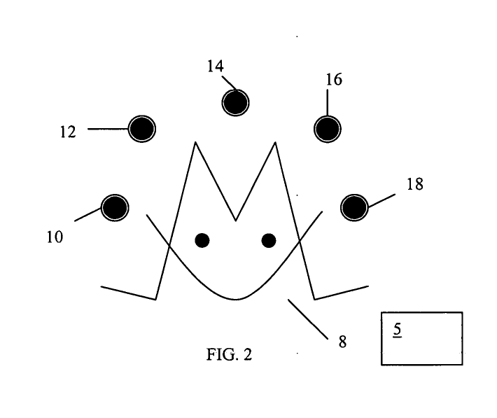

Referring to FIG. 2, there is a first level user interface 5. User interface 5 preferably appears on a screen that is remote from the computing device 1, for instance, a television display. The first level user interface 5 is defined by a media graphical 8. In a preferred embodiment, the media graphical 8 appears on the center of the screen and is a color that is in contrast with the background. For instance, the media graphical may be dark gray, against a cream-colored background. The content selections 10-18 are represented in a manner that each selection is easily distinguished from one another. In this example, content selections 10-18 are each represented by balls but each having a unique color—red, green, blue, orange and purple. Additionally and optionally, on each content selection 10-18 there may be a figure that represents the content. For instance, an image generally associated with a movie icon, notes for representing music icon, a video camera icon for representing home video, a still camera icon for representing photos, and an arrow icon that may provide a placeholder for either another type of content or for performing additional tasks such as receiving broadcast media such as television or radio. Note that there are alternative ways to demonstrate content selections, for instance, each content selection having a uniform color but each having unique shapes.

The user interface of FIG. 2 includes a dynamic interactive display. To select a content, for instance, 24 at FIG. 2A, the user points a selection device that is coupled to the interface, such as a remote control. The user presses a predefined button on the remote control and causes the content selections 10-18 to rotate in a circular motion, clockwise or counterclockwise relative to the display graphical 8, depending on the buttons pressed on the remote control. Each of the balls may further rotate about its own axis for further visual experience for the user, all the while displaying each of the media icons within the balls (not shown). When the desired content selection appears at the top and is the center ball of the five balls, the user then presses the remote control again and the second level interface associated with the selected ball appears.

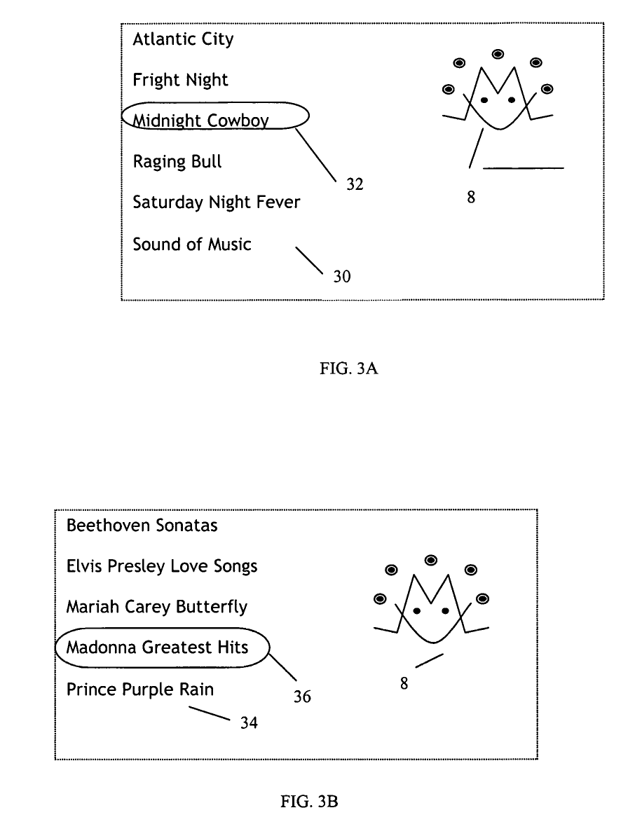

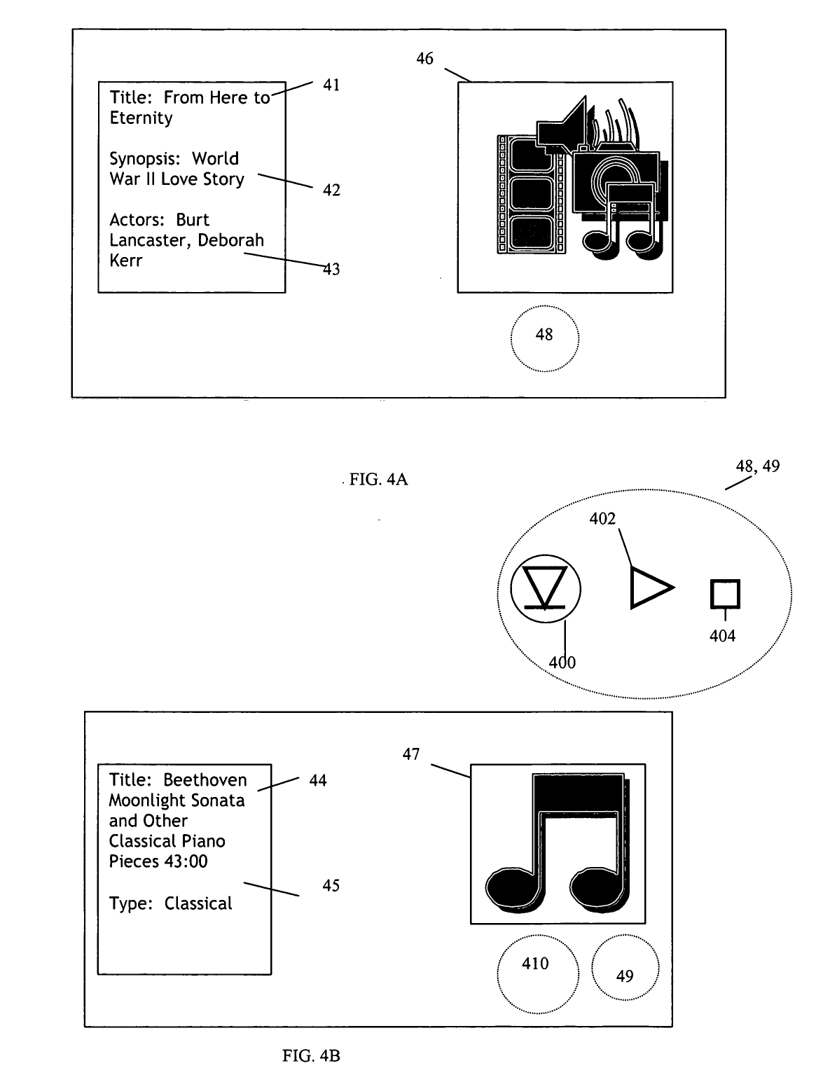

The next interface at FIG. 3 may be disposed on a new screen or may be shared with first level interface (FIG. 2), and may further include or not include graphical 8. In the exemplary embodiment, there are at least three second level interface displays, each on their own screen separate and distinct from first level interface (FIG. 2). Referring to FIG. 3A, the display appears when the content representing movies is selected. The display of FIG. 3A includes a file listing 30 of the library of movies. The file listing is created either by a factory preloaded set of digitized movies in a memory storage (6 of FIG. 1) or the user may input each desired movie by loading DVD's and importing them to create a personal library stored in memory (6 of FIG. 1). A remote control is used to cause a selector 32 to move up and down the file listing 30. When a desired title is reached, the user presses a button on the remote control to cause the title to be selected, at which time another user screen appears (FIG. 4).

FIG. 3B demonstrates the file library 34 associated when the user selects music represented by ball 12 placed at the top most position of graphical display 8. The file library 34 is created either by a factory preloaded set of digitized music in a memory storage (6 of FIG. 1) or the user may input each desired music album by loading CD's and importing them to create a personal library stored in memory (6 of FIG. 1). A remote control is used to cause a selector 36 to move up and down the file listing 34. When a desired title is reached, the user presses a button on the remote control to cause the title to be selected. Then, another user screen appears (FIG. 4).

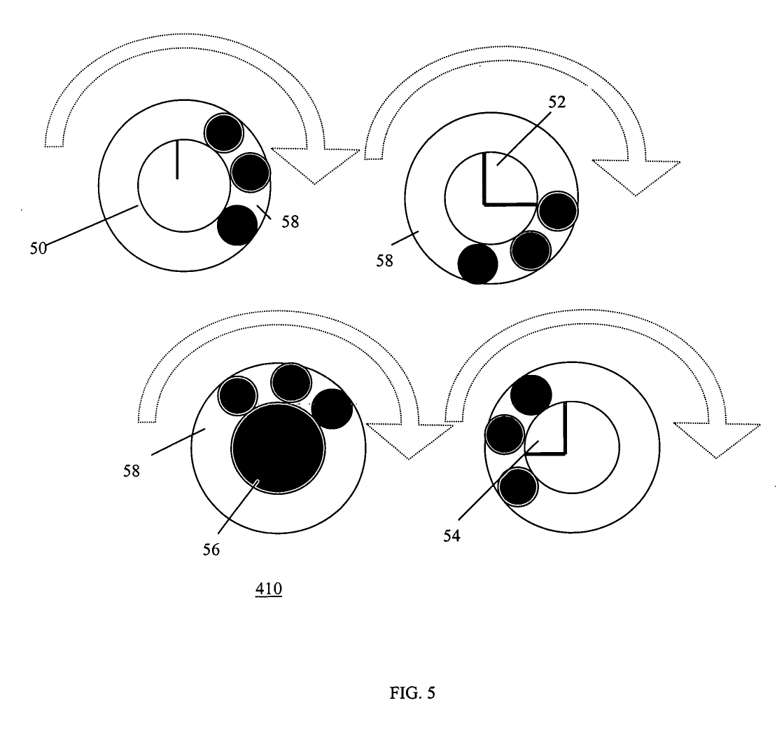

The display of FIG. 4 is a dual display that is preferably oriented side-by-side. On the left hand side there is presented written information of the selected item, and on the right hand side there is presented a graphical. For instance, in the case of a movie represented at FIG. 4A, there may be a title 41, a synopsis 42, and an actor listing 43. In the case of a music album represented at FIG. 4B, there may be a title 44 with associated play length and type 45, such as rhythm and blues, classical, hip-hop, country or rock. On the right hand side of the display there is presented a reproduction of the cover art 46 in the case of a movie and 47 in the case of a music album. Directly below the cover art 46, 47, there is displayed an icon set 48, 49 that allows the user to select import 400, play 402 or stop 404. Additional options such as fast forward or backward may also be added. Finally, there is included a progress indicator 410, which will be explained more fully in reference to FIG. 5.

FIG. 5 represents four snapshot positions of a progress indicator 410. Progress indicator 410 is a round icon that includes two concentric portions 50, 58 that each move. Moving portions 50, 58 move about a predefined radius and preferably, each move in a clockwise direction. Moving portion 58 is located in an outer radius relative to inner moving portion 50. Moving portion 58 moves along the outer edge of progress indicator 410 at a predefined rate, the rate being proportional to a clock. For instance, moving portion 58 may make a complete revolution about a center axis every two seconds. Moving portion 58 moves at a constant speed. Graphically, moving portion 58 may appear as moving single beads, each bead having a lighter shade than the other to create an impression of a trailing shadow. Or moving portion 58 may be a solid annular ring with a contrasting color portion as the moving component. Other options may be designed into moving portion 58 to graphically represent a constantly moving portion about another shape (which in this case is a circle). Moving portion 50 is represented here as if it were hands on a clock. Moving portion 50 represents the progress of content that is playing and moves relative to the proportion of completion. For instance, if the content is four minutes, then in one minute the moving portion 50 will move in one minute to a position representing one-quarter completion 52, in three minutes the moving portion 50 will move to a position representing three-quarter completion 54 and in four minutes the moving portion 50 will move to a position representing completion 56.

Whereas outer moving portion 58 moves in proportion to a standard clock, inner moving portion 50 is programmed to move about a circle in pre-defined segments, for instance, in increments of five percent toward completion. Each segment of completion is calculated based on the computer's (FIG. 1) software first reading the playing length of a content, subdividing the time into segments, applying the segments to the progress indicator 410. Whereupon, progress indicator 410 displays progress represented by inner moving portion 50 moving in percentage completion segments. Progress indicator 410 begins moving upon a user selecting “play” for a content, and stops moving when the content is stopped, either upon completion or if it is stopped during play by the user. The extent of movement of progress indicator 410 is in accordance with the percentage of completion of play of the selected content. Progress indicator 410 shows completed progress 56 if the content is played to completion. If a user stops the content short of completion, then progress indicator 410 shows the percentage completed by the position of inner moving portion 50.

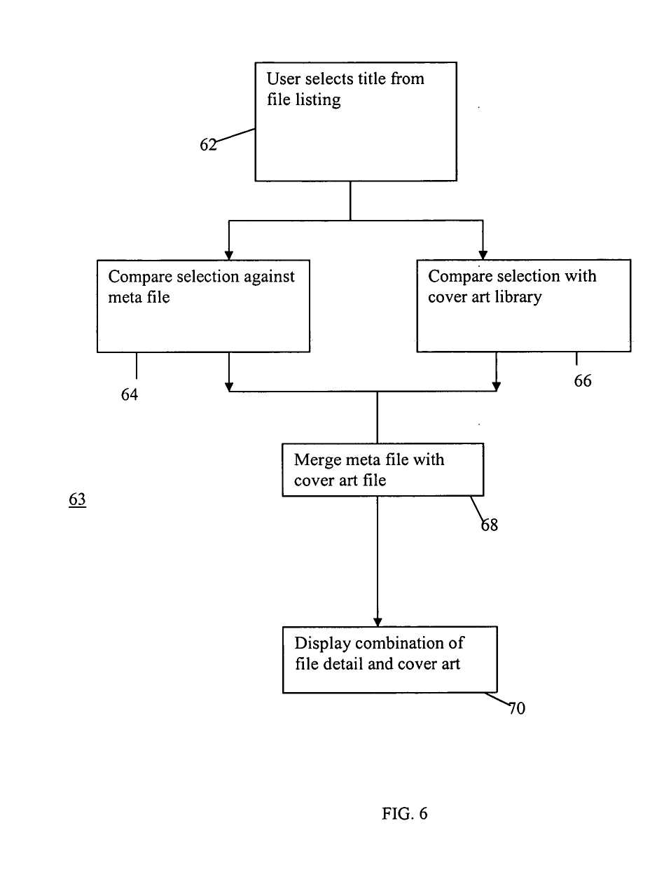

FIG. 6 represents a process of creating the third level display of FIG. 4A-4B in an automated fashion. First, at 62, a user selects a title from the file listing of the second level interface (FIG. 3). Then, the software behind the user interface performs a parallel process 63 that, at 64, compares the selected title against a first pre-installed library file 64 that includes written content descriptive of the title (synopsis, actors), and at 66, compares the selected title against a second pre-installed library file of cover art. Once the information matching the title selection is pulled from the two libraries, then the information is merged, as indicated in 68. Finally, the merged content combining the first pre-installed library file and second pre-installed library file is displayed 70 side to side on a screen.

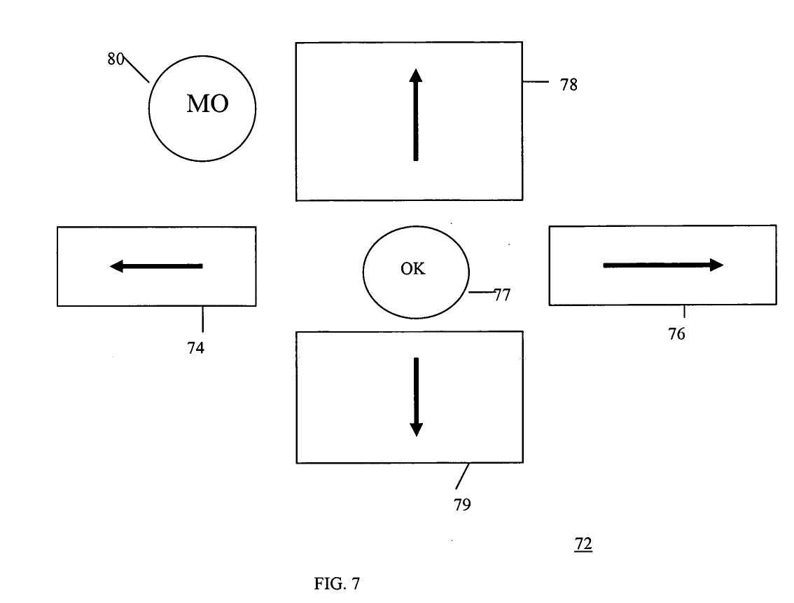

Referring to FIG. 7, a simple configuration of remote control buttons is preferred to create a minimally complex user experience. When the computing device (FIG. 1) is first started, the highest level user display (FIG. 2) appears. Remote control 72 may then be engage to manipulate balls 10-20 on the screen. By pressing the left-hand button 74, the user causes balls 10-20 to carousel to the left. By pressing the right-hand button 76, the user causes balls 10-20 to carousel to the right. When a desired ball reaches the center position, the user presses the OK button at 77 to select the content. When OK button 77 is selected, the second level user display (shown in FIG. 3) appears. At the second level user display (FIG. 3), the user may use the up arrow 78 and down arrow 79 keys to scroll up and down the title listing 30, 34. When a desired title is reached using the circle selector 32, 36, the user presses the OK button 77 to select the title. Whereupon, the third level screen (FIG. 4) may appear. Note that for some types of content, there may not be required (or desired) a third level screen. For instance, if the title listing is a set of photo albums, by selecting the desired title then the photo album may immediately appear as a slide show.

At any time, user may press MO 80. The MO 80 button serves at least two functions. If MO 80 button is pressed once during the playing of content, then the MO 80 button causes the play to immediately stop and if applicable, the user interface screen describing the particular media content will appear. For instance, the user may be watching a movie, and wishes to stop the movie before it has completed. The user presses MO 80 and the content stops. The user presses MO 80 again, and the display screen prior to the movie play screen appears. In other words, the third level screen (FIG. 4) would appear showing the cover art 46 and written information 41, 42, 43 for the movie. To resume play, the user presses OK 77. To revert back to the previous user interface display level, the user presses MO 80 again. If the user wishes to switch to a different type of content, the user presses MO 80 again, and the previous level screen appears (FIG. 3). The user presses MO 80 again, and the first level screen appears (FIG. 2). Whereupon, the user may use the left hand arrow key 74 and right hand arrow key 76 as desired to cause the balls 10-20 to carousel about their circle of rotation until the desired ball reaches the top and center position. Whereupon, the user presses OK 77 and the user may enjoy the selected content.

The exemplary embodiments as described in this disclosure are provided as exemplary embodiments to an overall invention pertaining to a user-friendly interface for enjoying electronic content. The user interface and components therein may be created using known-software programming techniques including the language C, C++, and Open GL. Alternatively, the interface and components therein may be generated by embedded executable commands in hardware. For the computing device, it is preferred that a graphics processor be used in conjunction with the required data processor, to achieve visually stimulating graphic displays. The computing device may be a self-contained appliance or it may be connected to the internet or to a network. The remote control device is programmed to interact with the computing device using known programming techniques. The invention described in the context of embodiments should not be construed as being limited to the embodiments provided here, and may be implemented by persons of ordinary skill in the art in various forms within the boundaries of the claims provided below.

What is claimed as new and desired to be protected by Letters Patent of the United States is:

1. A computer readable medium useful for a device for enjoying content via a content viewing apparatus, the computer readable medium including an application code that is capable of interacting with a signaling control device and which performs the steps of:
displaying a first graphical user interface that includes a plurality of movable icons each representing a content category, each icon moving in a predefined manner;
moving a first one of the movable icons to a desired position; and
displaying a second graphical user interface that generates an image that is related to the first one movable icon.

2. The computer readable medium of claim 1, wherein the movable icons move by rotating in a group about a center axis.

3. The computer readable medium of claim 1, wherein the step of moving one of the movable icons to a desired position includes moving the movable icon to a position that is higher than the other movable icons.

4. The computer readable medium of claim 1, wherein each of the movable icons further each comprise its own color.

5. The computer readable medium of claim 1, wherein each of the movable icons further each include its own graphical representing a content category.

6. The computer readable medium of claim 1, wherein the step of displaying a second graphical user interface includes:
retrieving a list of files associated with the one movable icon, wherein the list of files represents previously stored content within a content category;
displaying a first list of files in a first part of the viewing apparatus;
providing a movable highlight on the list of files;
selecting a file by moving the movable highlight to the desired file; and
playing the content associated with the selected file.

7. The computer readable medium of claim 6, further including the step of:
displaying the first graphical user interface in a second part of the viewing apparatus.

8. The computer readable medium of claim 7, further including the steps of:
causing the movable icons of the first graphical user interface to move;
causing a second one of the movable icons to move to a desired position; and
causing a third graphical user interface to be displayed, the third graphical user interface including a second list of files associated with the content category of the second one movable icon and having a movable highlight on the second list to enable the selection of a file.

9. The computer readable medium of claim 6, wherein the step of playing the content associated with the selected file includes the steps of:
providing a pre-existing library of descriptions associated with selectable content;
when a file is selected from the second file listing, generating a written description of the content of the selected file by retrieving the contents of the pre-existing library that are associated with the selected file and displaying the written description in a first part of the viewing screen;
providing a pre-existing library of cover art associated with selectable content; and
selecting from and displaying the pre-existing library the cover art associated with the content of the selected file in a second part of the viewing screen.

10. The computer readable medium as in claim 9, further including displaying in a third part of the viewing screen at least one icon previously defined and associated with enjoyment of the content.

11. The computer readable medium as in claim 10, further including displaying icons previously defined and associated with play and stop, wherein the icons respond to signals to cause the content to play or stop.

12. The computer readable medium as in claim 11, further including displaying an icon previously defined and associated with importing content, wherein the icon responds to a signal to cause content that has been stored on a physical medium and received by the content-enjoyment device to be stored in the file storage.

13. The computer readable medium as in claim 1, wherein the viewing apparatus is a television screen.

14. The computer readable medium as in claim 6, further including displaying a movable progress indicator icon that moves in response to the commencement of playing the content.

15. The computer readable medium as in claim 14, wherein the movable progress indicator includes a circular shape having a rotating component that rotates in response to actual time.

16. The computer readable medium as in claim 14, wherein the movable progress indicator includes a circular shape having a rotating component that rotates in response to percentage completion of the playing content.

17. The computer readable medium as in claim 14, wherein the movable progress indicator includes two concentric rings, the first ring moving in response to actual time, and the second ring moving in response to percentage completion of the playing content.

18. A method of monitoring the progress of timed media content via a user interface on a display implementing an application code over a computer readable medium, comprising the steps of:
commencing the play of the media content;
providing a first movable graphical in the display; and
providing a second movable graphical in the display, wherein the first movable graphical moves in accordance with actual time, and the second movable graphical moves in accordance with percentage completion of the timed media content.

19. A computer readable medium comprising application code and is capable of playing media content which implements the procedures of:
displaying a first graphical user interface, the first graphical user interface having a plurality of icons each associated with a category of content, each being selectable by a user;
upon selection of an icon, displaying a second graphical user interface, the second graphical user interface displaying an index of media files associated with the selected icon, any one of the media files being selectable by a user;
upon selection of a media file, displaying a third graphical user interface, the third graphical interface defining two window panes, wherein in one window pane is displayed a written summary associated with the selected media file and in the other window pane is displayed a cover art associated with the selected media file.
